(19) United States
(12) Patent Application Publication
(10) Pub. No.: US 2011/0249612 A1
(43) Pub. Date: Oct. 13, 2011

(54) Wireless communication system preventing traffic from being relayed concentratively onto a specific node

(75) Inventors: Yuki Kubo, Osaka (JP); Masanori Nozaki, Osaka (JP); Hiroshi Nishimura, Osaka (JP); Kentarou Yanagihara, Hyogo (JP)

(73) Assignee: OKI ELECTRIC INDUSTRY CO., LTD., Tokyo (JP)

(21) Appl. No.: 13/064,179

(22) Filed: Mar. 9, 2011

(30) Foreign Application Priority Data
Apr. 12, 2010 (JP) 2010-091516

(51) Int. Cl. H04B 7/14

(52) U.S. Cl. 370/315

(57) ABSTRACT

In a wireless communication network system performing multi-hop wireless communications, a network node has a calculator for exchanging control packets with its neighboring nodes to calculate link cost values, another calculator for calculating path costs incurred on the way to a network node of interest, a manager for managing the number of downstream nodes subsidiary to each daughter node, and a downstream node adjuster for adjusting the number of the downstream nodes subsidiary to each daughter node. The adjuster produces control information, into which link cost and/or path cost information is inserted. The adjuster adjusts the contents of the link cost or path cost information, to be inserted into the produced control information, according to the numbers of the downstream nodes subsidiary to the daughter nodes.

### BACKGROUND OF THE INVENTION

1. Field of the Invention

The present invention relates to a telecommunications network node, and more particularly to a telecommunications network node for use in, for example, a wireless communication network system which performs multi-hop wireless communications between network nodes.

2. Description of the Background Art

Conventionally, a solution for routing communication traffic in a wireless communication network system that effects multi-hop wireless communications between nodes is taught by “ZigBee Specification Revision 17 (ZigBee Document 053474r17), ZigBee Standards Organization, presented on the website of ZigBee (trade name) Alliance on the Internet, searched on Mar. 20, 2010, <http://www.zbsigj.org/download/085224r00ZB_MG-ZigBee-Specification-053474r17_Japanese_081209.pdf>.

According to the ZigBee Specification Revision 17, the start, or source, node floods route requests (RREQs) to broadcast them over the whole network. In reply, the end, or destination, node unicasts route replies (RREPs) to the start node. Consequently, between the start and end nodes, paths are formed, see paragraph 3.6.3.5 of the ZigBee Specification. According to paragraphs 3.4.1 and 3.4.2 of the ZigBee Specification, the frame of the RREQs and RREPs has a path cost field, which contains the total sum of link costs on the links between the start and end points, the link cost representing the value of the quality of link. The path cost is used to effectively select one of the paths which has the optimum quality, i.e. the lowest path cost.

This method permits a path to be obtained between two nodes. A many-to-one communication system in which one-to-plural node communications established between a sink node and plural destination nodes is also described in the ZigBee Specification. In the many-to-one system also, an upstream path to a sink node may be obtained by almost the same procedure. The method of selecting a path attaining the minimum sum of link costs as the optimum path is widely used in this way in routing traffic in wireless multi-hop networks.

According to the ZigBee Specification Revision 17, a link cost is computed from a link quality indicator (LQI) value when an RREQ command is received. In another available method, more precisely calculating link costs, control packets, such as Hello packets, are periodically transmitted from a network node, and the rate at which the control packets are received are actually measured. In this method, a network node of interest measures the rate of reception of Hello packets from other nodes capable of direct communications, i.e. neighboring nodes, and sets the measured result in Hello packets to send the latter to its neighboring nodes to thereby inform the neighboring nodes of the rate of reception. Consequently, it is possible for the node to know the rate of the sent Hello packets having arrived at the destination. Hence, the link quality can be obtained bidirectionally for each link.

In the routing method such as described by the ZigBee Specification Revision 17, from the viewpoint of a path of interest connecting start and end nodes, it would be possible to select a better path involving a smaller path cost. However, when, in a communication system, for example, traffic occurs to convey data from plural start nodes to a single end node directly or via other nodes, it may be better in some cases to select a path from the viewpoint of preventing traffic from concentrating at intermediary nodes rather than from the viewpoint of path costs. In small-scale networks, such traffic concentration would rarely be problematic. However, a network formed by hundreds of nodes to gather data would involve such traffic concentration on intermediary nodes. Furthermore, it is also important to prevent an intermediary node from being connected to a downstream node exceeding the intermediary node in processing capacity.

### SUMMARY OF THE INVENTION

It is therefore an object of the invention to provide a telecommunication network node capable of suppressing traffic from concentrating on a relaying node.

According to the present invention, a network node performing multi-hop wireless communications comprises a control information transmitter/receiver sending or receiving a control packet containing control information to or from a neighboring node directly with which the network node can wirelessly communicate, a link cost calculator which is operative in response to the control information transmitter/receiver sending or receiving the control information to calculate a link cost value of a link between the network node and the neighboring node, a path cost calculator calculating, when a packet is sent to a destination node, a path cost value incurred until the packet arrives at the destination node, a downstream node manager managing the number of downstream nodes subsidiary to a daughter node of the network node on a path over which the packet sent arrives at the destination node, and a control information producer producing the control information to be sent by the control information transmitter/receiver. The control information producer inserts, into the information to be produced, link cost information based on the link cost value calculated by the link cost calculator and/or path cost information based on the path cost value calculated by the path cost calculator. The control information producer is operable in response to the number of the downstream nodes subsidiary to the daughter node to adjust the content of the link cost information or the path cost information, to be inserted into the control information to be produced, to thereby adjust the number of the downstream nodes subsidiary to the daughter node.

Also according to the invention, a wireless communication network system is provided which comprises the network node defined in the preceding paragraph.

According to the present invention, a wireless communication network system performing multi-hop wireless communications can prevent traffic from being concentratively relayed onto a specific node.

### BRIEF DESCRIPTION OF THE DRAWINGS

The objects and features of the present invention will become more apparent from consideration of the following detailed description taken in conjunction with the accompanying drawings in which:

FIG. 1 is a schematic block diagram showing the functional configuration of a telecommunications network node in accordance with a preferred illustrative embodiment of the present invention;

FIG. 2 exemplarily shows the network topology of a wireless communication network system formed by the nodes in accordance with the illustrative embodiment shown in FIG. 1;

FIG. 3 schematically shows the topology shown in FIG. 2 with link costs adjusted;

FIG. 4 exemplarily shows, like FIG. 2, the network topology of a wireless communication network system including telecommunications network nodes in accordance with an alternative embodiment of the invention;

FIG. 5 is a schematic block diagram, like FIG. 1, showing the functional configuration of a network node forming the network shown in FIG. 4; and

FIG. 6 schematically shows, like FIG. 3, the topology shown in FIG. 4 with path costs adjusted.

### DESCRIPTION OF THE PREFERRED EMBODIMENTS

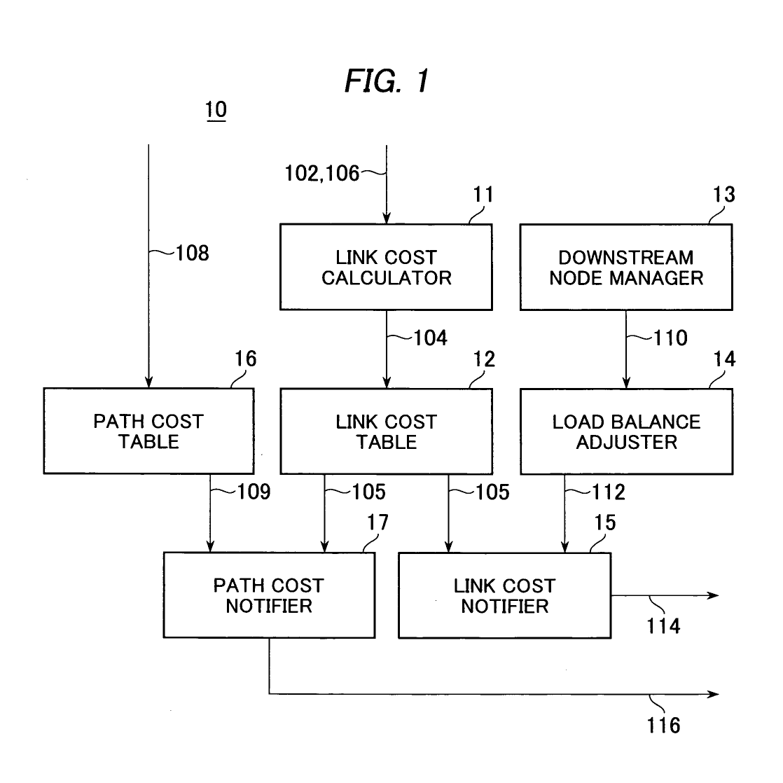

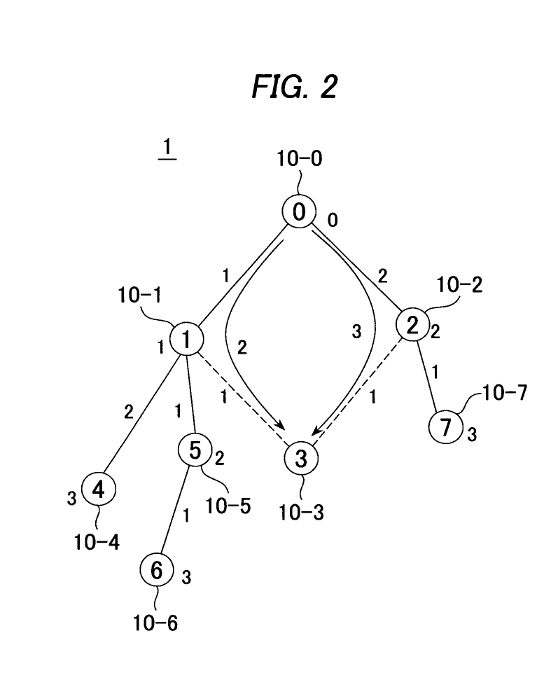

An illustrative preferred embodiment of a wireless communication network system according to the present invention will be described in detail with reference to FIGS. 1, 2 and 3. Reference will be made first to FIG. 2 to describe the network topology of a wireless communication network system, generally 1, according to an illustrative embodiment of the invention. As seen from the figure, only for the purpose of illustration, the wireless communication network system 1 includes eight network nodes 10-0 to 10-7, which may be the same in configuration as each other and therefore simply be referred to as nodes 10 also. FIG. 2 shows an example in which each of the nodes 10-1 to 10-7 sends data to the node 10-0 by multi-hop communications. In the figure, the solid or dotted lines interconnecting nodes 10 represent that both nodes on each of the lines can directly communicate with each other wirelessly.

The internal structure of each node 10 will next be described with reference to FIG. 1, which schematically shows in a block diagram the functional configuration of the node 10. Generally, the network node 10 includes a link cost calculator 11, a link cost table 12, a downstream node manager 13, a load balance adjuster 14, a link cost notifier 15, a path cost table 16, and a path cost notifier 17.

The node 10 may be implemented as a communication unit including, for example, an interface, not shown, adapted for performing wireless communications, and a processor adapted for processing communication control and data and having wireless communication programs installed for implementing the functional configuration shown in FIG. 1.

The illustrative embodiment of the node 10 is depicted and described as configured by those functional blocks. It is however to be noted that such a depiction and a description do not restrict the node 10 to an implementation only in the form of hardware but may partially or entirely be implemented by software, namely, by a computer, or processor system, which has a computer program installed and functions, when executing the computer program, as part of, or the entirety of, the functional configuration of the node 10 shown in FIG. 1. That may also be the case with an alternative embodiment which will be described later. In this connection, the word “circuit” or “section” may be understood not only as hardware, such as an electronics circuit, but also as a function that may be implemented by software installed and executed on a computer.

The link cost calculator 11 is adapted to calculate link cost values for reception of packets from each neighboring node according to the conditions, e.g. the rate of successful reception and/or the intensity of received radio waves carrying the packets, of the reception of control packets 102, such as Hello packets, from a neighboring node 10 capable of direct communications therewith to store the resultant values into the link cost table 12 as link cost values on the receiver 104 side for that link. Upon receiving packets carrying link cost information 106, described later in further detail, sent by the link cost notifier 15 of a neighboring node, the calculator 11 itself checks whether or not the link cost information includes the link cost value on the sender side for that neighboring node. If so, the link cost value is stored into the link cost table 12 as the link cost value on the sender side for that link. It is to be noted that information, data or signals are designated with reference numerals of connections on which they are conveyed.

If, about a neighboring node, the link cost values on the sender and receiver sides are both already known, then the link cost calculator 11 examines those cost values integrally to thereby calculate a link cost value, and stores the resultant value into the link cost table 12.

Note that the above specific method of calculation is not restrictive, but, alternatively, an averaging method or a method of selecting a worse value may be applied. Also, the method of calculating link cost values by the link cost calculator 11 is not restrictive. For example, a method is available which utilizes the function of periodically sending out control packets such as Hello packets, or uses the LQI values of data packets to simply calculate link cost values. In computing link cost values by the link cost calculator 11, use may be made of link cost values on either of the sender and receiver sides.

The link cost table 12 functions, in the form of storage, as storing information such as link cost values 104 determined by the link cost calculator 11 for each neighboring node. On the link cost table 12, there are stored, for each neighboring node link, cost values on the receiver and sender sides, as well as link cost values determined therefrom.

In FIG. 2, numerals attached to dotted or solid lines connecting nodes 10 indicate link cost values determined with respect to both nodes. The figure is drafted on the assumption that link costs calculated at two nodes 10 interconnected by respective dotted or solid lines are equal to each other.

The path cost table 16 serves, also in the form of storage, as storing contents of path cost information received from neighboring nodes 108 for each neighboring source node. The path cost table 16 may be adapted to store, for example, path cost information received from a neighboring node in connection with identification information such as the address of the node in a set.

The path cost information stored in the path cost table 16 includes information, e.g. identification information such as address information, about a node of interest 10, and information about the path cost value incurred on the path to that node 10. For example, in the network shown in FIG. 2 in which paths may be formed from one node 10-0 to other plural nodes 10-1 through 10-7, if the path costs may be defined in advance as with respect to the node 10-0, then the path cost information may be void of the description “information on a node of interest”.

The path cost table 16 and the link cost table 12 thus store a kind of attribute values with respect to the address of each neighboring node. Such attribute values may associatively be stored and managed on one and the same table. The path cost table 16 may be adapted for integrally managing such information about neighboring nodes on a neighboring node table as done in existing wireless communication devices.

In each node 10, the contents of the path cost table 16 and link cost table 12 are used to select a path for packet transmission to a destination node 10. For example, the node 10 references the contents of the two tables 16 and 12 to select a path incurring the minimum path cost up to the destination node 10 of packets to be transmitted, and selects first one of the nodes 10 on the selected path as a mother node to which packets will be transmitted first in the topology.

In the wireless communication network system 1, each node 10 selects a path with the node 10-0 taken as a destination of packets to be transmitted to thereby select its mother node. As a result, the tree-type network as shown in FIG. 2 will logically be formed.

The downstream node manager 13 functions as managing nodes located downstream, or subsidiary to, the subject node 10 on which the manager 13 is installed. The downstream node is a node 10 from which packets are relayed by the subject node 10. For example, in the example shown in FIG. 2, when packets meant for the node 10-0 are transmitted, the node 10-1 relays packets sent out from the nodes 10-4, 10-5 and 10-6, which are downstream nodes subsidiary to the node 10-1. The downstream node manager 13 of the node 10-1 manages the downstream nodes of the node 10-1 in such a fashion that, when the nodes 10-4, 10-5 and 10-6 send packets to the node 10-0, the manager 13 of this node 10-1, necessarily relaying those packets, will record the source nodes of the packets as downstream nodes. Furthermore, nodes 10 that have sent packets for enabling data transmission or the like to that node 10-1 are also downstream nodes.

For example, in the geometry shown in FIG. 2, when each node 10 sends packets meant for the node 10-0, all the nodes are downstream nodes with respect to the destination node 10-0. In addition, in each of the downstream nodes in the geometry, the downstream node manager 13 makes a record representing which of its neighboring nodes the node of interest, i.e. the source node of a packet of interest in the context, is located downstream. For example, when viewed from the node 10-0, it is difficult to know how further the node 10-6 is located downstream, i.e. how many hops it resides downstream from the node 10-0. However, when a packet is transmitted to the node 10-0 via the node 10-1, it is possible for the node 10-0 to determine from the contents of its header information that the packet has passed the node 10-1.

The downstream node manager 13 of each node 10 thus records which of its neighboring nodes 10 an incoming packet has passed. That renders it possible, for example in the situation stated above, that the node 10-0 can know that the node 10-6 is located downstream itself and further downstream its neighboring node 10-1. This way of management is effective on any packets so far as they contain the source and destination addresses in the header thereof. However, where applied is another routing method, such as source routing, in which nodes having relayed packets are all recorded on a table, such downstream information may also be recorded on that table in connection with such nodes.

In this manner as described above, the downstream node manager 13 of a subject node 10 grasps, for each node of interest 10, the number of downstream nodes on the paths followed down to the node of interest 10 with respect to each of its daughter nodes in the topology directly with which the subject node 10 can wirelessly communicate.

The downstream node manager 13 of a subject node 10 may be adapted to delete a record on a downstream node from which the subject node 10 has not received any packets during a predetermined period of time. Furthermore, in the illustrative embodiment, the manager 13 does not deal with the subject node 10 on which it is installed as a downstream node. The manager 13 may be adapted for dealing with the subject node 10 as a downstream node.

With respect to the subject node 10 in which the downstream node manager 13 is included, when a downstream node located downstream a daughter node has switched its connection to a downstream node positioned downstream another daughter node, then the downstream node manager 13 of the subject node 10 may update the record by erasing the record on the former downstream node and using information contained in a packet received most recently to make a new record stating that the downstream node in question is subordinate to the other daughter node thus newly switched.

Now, returning to FIG. 1, the load balance adjuster 14 is adapted for using the result 110 of the processing performed by the downstream node manager 13 to control an adjustment such that the neighboring nodes, i.e. daughter nodes with which the subject node 10 in which the adjuster 14 is included can directly communicate, have downstream nodes optimized in number. The adjustment contents 112 will be reflected on the operation of the link cost notifier 15.

If all the nodes 10 are substantially equal in processing capacity to each other, then the load balance adjuster 14 of a subject node 10 controls the adjustment such as to make substantially even the numbers of downstream nodes between its neighboring nodes.

For example, in the geometry shown in FIG. 2, when excluding the node 10-3, the downstream nodes of the node 10-0 when packets are transmitted to the node 10-0 are nodes 10-1, 10-2, 10-4, 10-5, 10-6 and 10-7 while the neighboring nodes are nodes 10-1 and 10-2. The downstream nodes subsidiary to the node 10-1 are nodes 10-1, 10-4, 10-5 and 10-6, and the downstream nodes subsidiary to the node 10-2 are nodes 10-2 and 10-7.

In this case, the node 10-0 grasps that its daughter node 10-1 has four downstream nodes and that its other daughter node 10-2 has two downstream nodes. Thus, the node 10-1 has its downstream nodes more than the other node 10-2. In this example, the former node 10-1 will has to be reduced in number of its downstream nodes. The load balance adjuster 14 of the node 10-0 will inform its link cost notifier 15 of the adjustment necessary to increase the link cost incurred for connection with the node 10-1.

When the node 10-1 has its processing capacity exceeded, e.g. when the number of downstream nodes exceeds a predetermined threshold value, the load balance adjuster 14 of the node 10-0 may additionally notify its link cost notifier 15 of the incapability that the node 10-1 would not have any additional downstream nodes subsidiary thereto.

The load balance adjuster 14 may be adapted, where those nodes 10 may be different in processing capacity from each other, to control an adjustment such that the downstream nodes will be proportional in number to the processing capacity thereof.

The link cost notifier 15 functions to insert the information 105 contained in the link cost table 12 as link cost information into control packets 114, such as Hello packets to transmit the packets 114 to the neighboring nodes. At this time, if the link cost notifier 15 has received a notice of adjustment 112 from the load balance adjuster 14, the notifier 15 provides a corresponding notice to the neighboring nodes.

In-an example where the nodes 10-1 and 10-2 stay near the node 10-0 and the respective link costs are “1” and “2” as shown in FIG. 2, if no adjustment is necessary, then the node 10-0 sends link cost information in the form of packets stating that the link cost values with the nodes 10-1 and 10-2 are “1” and “2”, respectively, to its neighboring nodes 10-1 and 10-2.

However, when account is taken of the node 10-1 having its subsidiary nodes more than the node 10-2 to increase nodes subsidiary to the node 10-2 in number, the notifier 15 of the node 10-0 sends link cost information adjusted in such a way that link cost values incurred when linked with the node 10-1 which is to be reduced in terms of downstream nodes are increased according to the numbers of downstream nodes subsidiary to the respective neighboring nodes. At this time, the notice, i.e. link cost information, produced and transmitted by the link cost notifier 15 may include, in addition to information about link cost values, an identifier indicating that the capacity of that node is exceeded as described above.

Thus, the nodes 10 may operate with restriction imposed in selecting paths, or in selecting a node having its path cost value exceeding an upper limit of path cost values set and added to link cost information to be sent, thereby preventing the downstream nodes from excessively increasing in number.

Such information other than simple numerical values is included in the link cost information, which can be propagated in the same way as link cost values are cumulative and propagated. With this method, a more appropriate selection can be attained when a terminal node 10 determines which of the paths to take.

The path cost notifier 17 inserts path cost information into control packets 116, e.g. Hello packets, the path cost information 109 including information about path cost values incurred from the subject node 10 in which notifier 17 is installed to a packet destination node 10, and then transmits the control packets to its neighboring nodes. The path cost value is obtained by referencing the path cost table 16 to get a path cost value of which the subject node 10 is notified from a node which the subject node 10 has selected as a mother node, and adding the obtained value to a link cost value incurred in respect to the mother node.

Now, in the example shown in FIG. 2, when the node 10-3 calculates the path cost value incurred on the way to the node 10-0, it has two possible paths. On one path passing the node 10-1, a path cost value of “1” of the node 10-1 is added to a link cost value of “1” of the node 10-1 to produce a resultant path cost value of “2”. On the other path passing the node 10-2, a path cost value “2” of the node 10-2 is added to a link cost value “1” of the node 10-2 to produce a resulting path cost value of “3”. In this case, the path going through the node 10-1 having the smaller path cost value is selected as the path to the node 10-0, so that the node 10-3 will have its path cost value to the node 10-0 equal to “2”. At this time, if the link cost information indicates that the capacity of a node has been exceeded, that node may be excluded from the path selection.

As described so far, the path cost notifier 17 determines a path cost value and sends to the neighboring nodes packets carrying path cost information including the determined path cost value. The- path cost information may be sent alone. If the path cost information is incorporated into a packet the link cost notifier 15 will transmit, a fewer number of packets may be transmitted.

In operation, the nodes 10 exemplarily form the topology of the wireless communication network system 1 shown in FIG. 2. Now, the nodes have sent out Hello packets, and have measured link cost values in between. Further, at this time, all the nodes 10, except the node 10-3, have selected paths to the node 10-0, and the downstream node manager 13 of the node 10-0 has grasped from the received uplink data packets that the nodes 10-1, 10-4, 10-5 and 10-6 stay downstream the node 10-1 and that the nodes 10-2 and 10-7 are located downstream the node 10-2.

Then, the node 10-3 exchanges Hello packets with the nodes 10-1 and 10-2 that are neighboring nodes. The link cost calculator 11 of the node 10-3 operates to calculate link cost values of links in cooperation with the link cost table 12 and link cost notifier 15. As a result, the link cost value between the nodes 10-3 and 10-1 is equal to “1” and the link cost value between the nodes 10-3 and 10-2 is also “1”, as depicted.

Also as shown, the node 10-3 has now grasped through the operation of the path cost table 16 and path cost notifier 17 that the path cost values of the nodes 10-1 and 10-2 to the node 10-0 are equal to “1” and “2”, respectively. It is resultantly revealed, with respect to the path to the node 10-0, that the path passing the node 10-1 would incur a path cost value of “2” for transmission while the path passing the node 10-2 would incur a path cost value of “3” for transmission. The node 10-3 now selects a path on which transmission to the node 10-0 will be made via the node 10-1.

Thereafter, when the node 10-3 sends data to the node 10-0, the downstream node manager 13 of the node 10-0 has the presence of the node 10-3 added to its downstream management data.

Now, the downstream nodes subsidiary to the node 10-1 are nodes 10-1, 10-3, 10-4, 10-5 and 10-6, and the downstream nodes subsidiary to the node 10-2 are nodes 10-2 and 10-7. Under this situation, the load balance adjuster 14 of the node 10-0 tries adjustment for making the downstream nodes even in number between its neighboring nodes to thereby add the value of link cost of the node 10-1 resultant from the calculation from the link cost notifier 15.

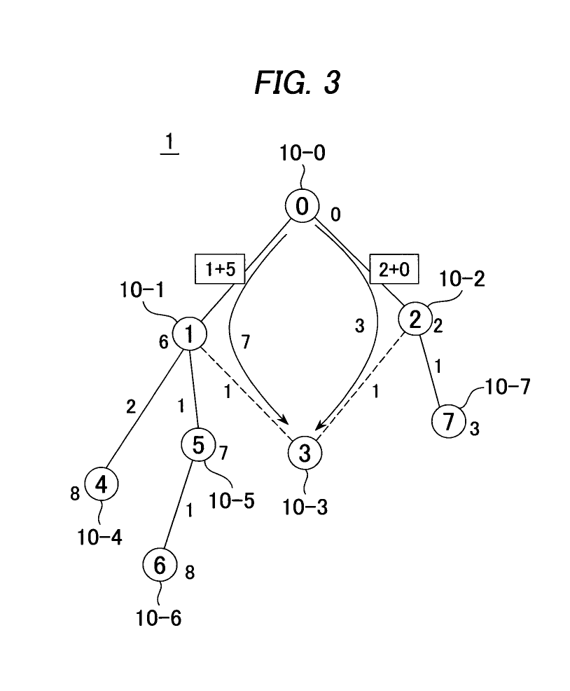

FIG. 3 shows in a topological diagram the state of the wireless communication network system 1 after link costs have been adjusted by the link cost notifier 15 of the node 10-0. In the illustrative example, the link cost notifier 15 of the node 10-0 has added a value of “5” to the link cost value of the node 10-1. As illustrated in the figure, the node 10-1 then assumes a path cost value of “6”, and, in the node 10-3, the path cost value of the path passing the node 10-1 is equal to “7”. Accordingly, the node 10-3 will switch its path to be used to the path passing the node 10-2.

In the example shown in FIG. 3, the link cost notifier 15 of the node 10-0 adds the value of “5” to the link cost value of the node 10-1. However, that specific value itself is not restrictive. In the node 10-0, the link cost notifier 15 may be adapted to add, as illustrated in FIG. 3, a predetermined, fixed value to the link cost value. Alternatively, the link cost notifier 15 of the node 10-1 may be adapted for adding a value corresponding to the difference in number of downstream nodes between its daughter nodes, 10-1 and 10-2 in this example. Further alternatively, the link cost notifier 15 of the node 10-0 may be adapted to increment the link cost value with respect to the node 10-1 until the number of downstream nodes of the node 10-1 becomes substantially equal to, or different by a predetermined value or less from, the number of downstream nodes of the node 10-2. The load balance adjuster 14 of the node 10-0 may also be adapted to control, once the node 10-2 has more downstream nodes than the node 10-1 after the link cost value of the node 10-1 has been adjusted, adjustment on the link cost value so as to conversely reduce the number of downstream nodes of the node 10-2.

The wireless communication network system 1 works as described so far to cause the numbers of downstream nodes to become substantially even between the nodes 10-1 and 10-2, the difference in between thus converging substantially to zero.

With the illustrative embodiment of the wireless communication network system 1 described above, the nodes 10 thus adjust the link cost values, so that it is possible to prevent traffic from being relayed concentratively onto a specific node 10. Consequently, a more optimal wireless multi-hop network can be provided.

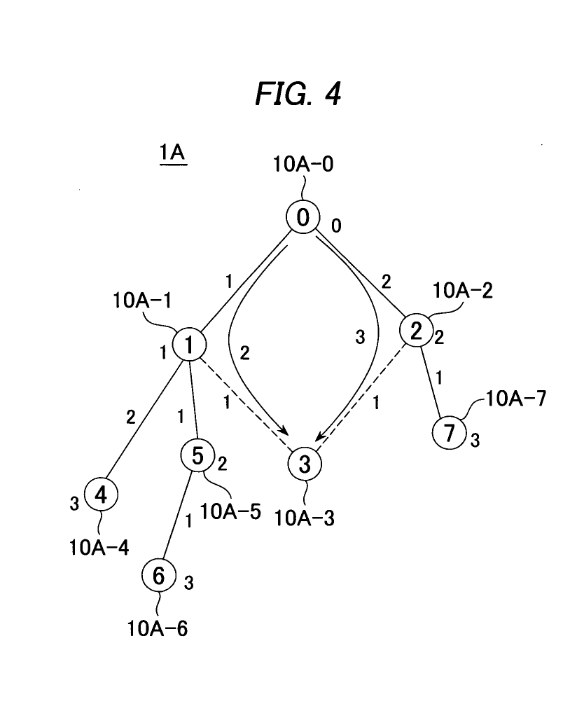

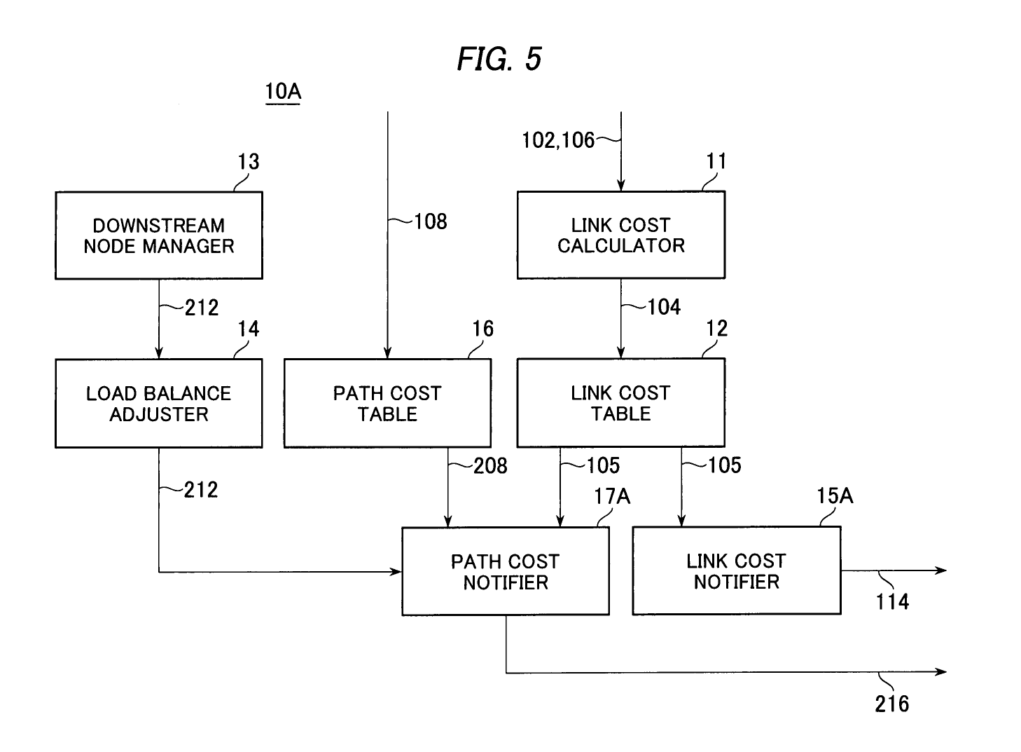

An alternative embodiment of the wireless communication network system according to the present invention will will be described in detail with reference to FIGS. 4, 5 and 6. FIG. 4 is a topological diagram showing the whole configuration of a wireless communication network system 1A of the alternative embodiment. The wireless communication network system 1A may be similar to the wireless communication network system 1 shown in and described with reference to FIGS. 2 and 3 with the nodes 10 of the system 1 replaced by nodes 10A. Thus, with reference to FIG. 5 showing, in a schematic block diagram, the functional configuration of the wireless nodes 10A, the differences of the nodes 10A from the nodes 10 of the system 1 of the earlier-described embodiment will be described.

In the alternative embodiment, the link cost notifier 15 and the path cost notifier 17 of the node 10 of the embodiment described with reference to FIG. 2 have been replaced by a link cost notifier 15A and a path cost notifier 17A, respectively. The wireless communication network system 1A may be the same as the system 1 except that the path cost notifier 17A is adapted to produce path cost information which reflects a result from processing performed by the load balance adjuster 14 to send the produced information to the neighboring nodes. Like components are designated with the same reference numerals, and repetitive description thereon will be omitted to avoid redundancy. It is to be noted that, unlike the illustrative embodiment shown in FIG. 1, the link cost notifier 15A may not be adapted to reflect a result from processing performed by the load balance adjuster 14 to adjust link costs.

The path cost notifier 17A functions as informing the neighboring nodes of path cost information 216 about path costs incurred on the way from the subject node 10A to a packet destination node 10A. The path cost values 208 included in the path cost information to be notified by the path cost notifier 17A is obtained by referencing the path cost table 16 to fetch a path cost value 208 of which the subject node 10A is notified from a node which the subject node 10A has selected as a mother node, and adding the obtained value to a link cost value incurred with respect to the mother node 10A, and further adding the resultant value to a value 212 notified from the load balance adjuster 14.

The path cost notifier 17A in turn sends to the neighboring nodes packets carrying path cost information 216 including the resultant path cost value. Therefore, the subject node 10A has to notify its neighboring nodes of path cost values which are different from neighboring node to node.

In the illustrative embodiment shown in FIG. 1, the node 10-0 can broadcast packets indicating that the past cost incurred in respect to itself is equal to “0”. In the alternative embodiment, daughter nodes are notified of path cost information having contents different from node to node, and therefore each daughter node may individually be notified via unicasting.

In operation, the nodes 10A of the alternative embodiment exemplarily take the state of the wireless communication network system LA as depicted in FIG. 4. More specifically, the nodes 10A have sent Hello packets, and currently have completed the measurement of link cost values in between. Further, at this time, all the nodes 10A, except the node 10A-3, have selected paths to the node 10A-0.

In this state, the node 10A-3 may operate similarly to the illustrative embodiment shown in and described with reference to FIGS. 1, 2 and 3 until a path passing the node 10A-1 is selected to the node 10A-0.

Thereafter, when the node 10A-3 sends data to the node 10A-0, the downstream node manager 13 of the node 10A-0 has the presence of the node 10A-3 added to its downstream management data.

Now, the downstream nodes subsidiary to the node 10A-1 are nodes 10A-1, 10A-3, 10A-4, 10A-5 and 10A-6, and the downstream nodes subsidiary to the node 10A-2. are nodes 10A-2 and 10A-7. Under this condition, the load balance adjuster 14 of the node 10A-0 tries an adjustment for rendering the downstream nodes even in number between its neighboring nodes to thereby add a predetermined value to the path cost value determined by the path cost notifier 17A.

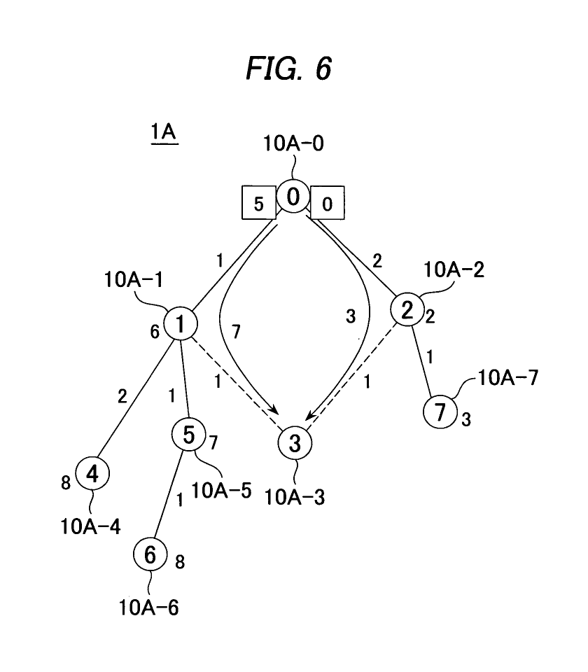

FIG. 6 is a topological diagram exemplarily showing the wireless communication network system 1A, in which, when the node 10A-0 tries to reduce in number the downstream nodes subsidiary to the node 10A-1, the path cost notifier 17A notifies the node 10A-1 of the path cost value, e.g. “5” while the node 10A-2 remains notified of the path cost value “0”. Then, as shown in FIG. 6, the node 10A-1 has its path cost value changed to “6”, so that the node 10A-3 has its path cost value through the node 10A-1 changed to “7”. Consequently, the node 10A-3 will switch its path to be used to the path passing through the node 10A-2.

In the example shown in FIG. 6, the path cost notifier 17A of the node 10A-0 adds the value of “5” to the path cost value which is to be transferred to the node 10A-1. However, the specific value per se is not restrictive. In the node 10A-0, the path cost notifier 17A may be adapted to add such a predetermined, fixed value as shown in FIG. 6 to the path cost value. Alternatively, the link cost notifier 15A may be adapted to add a value corresponding to the difference in number of downstream nodes between its daughter nodes, 10A-1 and 10A-2 in this example, of the node 10A-0. Further alternatively, the path cost notifier 17A of the node 10A-0 may be adapted to increment a path cost value to be transferred to the node 10A-1 until the number of downstream nodes of the node 10A-1 becomes substantially equal to, or different by a predetermined value or less from, the number of downstream nodes of the node 10A-2. The load balance adjuster 14 of the node 10A-0 may also be adapted to control, once the node 10A-2 has more downstream nodes than the node 10A-1 after the path cost value of the node 10A-1 has been adjusted, adjustment on the path cost value to be notified so as to conversely reduce the number of downstream nodes of the node 10A-2.

The wireless communication network system 1A works as described above to cause the numbers of downstream nodes to become substantially even between the nodes 10A-1 and 10A-2, the difference in between thus converging substantially zero.

With the alternative embodiment of the wireless communication network system 1A, the nodes 10A adjust the path cost values of which daughter nodes will be notified, thus making it possible to prevent traffic from being relayed concentratively onto a specific node 10A. Consequently, a more optimum wireless multi-hop network can be presented.

The present invention is not limited to the illustrative embodiments specifically described above but may be modified as exemplified below.

The wireless communication network systems 1 and 1A described above are entirely formed by the nodes of the respective illustrative embodiments of the present invention. However, a wireless communication network system may be formed by some nodes according to the invention and the remaining nodes different in configuration from the former nodes, such as conventional ones. Further, both nodes 10 and 11A of the respective embodiments may forma single wireless communication network system including conventional nodes.

For example, the present invention may be applied to a node acting as a mother node of a node which is expected to concentratively relay traffic. For instance, the embodiment shown in FIG. 1 may be applied only to the node 10-0 with the remaining nodes 10-1 to 10-7 may be conventional ones.

In the wireless communication network systems of the illustrative embodiments described above, packets may be destined for any of the nodes in the systems. A specific node may be operated as a sink node while the remaining nodes may be designed to send data to the sink node. For example, in the illustrative embodiment shown in FIG. 2, the node 10-0 may operate as a sink node while the remaining nodes 10-1 to 10-7 may act as nodes having a sensor and adapted to transmit sensed data to the node 10-0.

The entire disclosure of Japanese patent application No. 2010-91516 filed on Apr. 12, 2010, including the specification, claims, accompanying drawings and abstract of the disclosure, is incorporated herein by reference in its entirety.

While the present invention has been described with reference to the particular illustrative embodiments, it is not to be restricted by the embodiments. It is to be appreciated that those skilled in the art can change or modify the embodiments without departing from the scope and spirit of the present invention.

What we claim is:

1. A network node performing multi-hop wireless communications, comprising:
a control information transmitter/receiver sending or receiving a control packet containing control information to or from a neighboring node directly with which said network node can wirelessly communicate;
a link cost calculator which is operative in response to said control information transmitter/receiver sending or receiving the control information to calculate a link cost value of a link between said network node and the neighboring node;
a path cost calculator calculating, when a packet is sent to a destination node, a path cost value incurred until the packet arrives at the destination node;
a downstream node manager managing a number of downstream nodes subsidiary to a daughter node of said network node on a path over which the packet sent arrives at the destination node; and
a control information producer producing the control information to be sent by said control information transmitter/receiver,
said control information producer inserting, into the information to be produced, link cost information based on the link cost value calculated by said link cost calculator and/or path cost information based on the path cost value calculated by said path cost calculator,
said control information producer being operable in response to the number of the downstream nodes subsidiary to the daughter node to adjust a content of the link cost information or the path cost information, to be inserted into the control information to be produced, to thereby adjust the number of the downstream nodes subsidiary to the daughter node.

2. The network node in accordance with claim 1, wherein said downstream node manager references the content of a packet received by said network node from the neighboring node to thereby grasp the number of the downstream nodes subsidiary to the daughter node.

3. The network node in accordance with claim 1, wherein said control information producer adjusts the link cost value incurred with respect to the daughter node to be contained in the link cost information to be produced, according to the number of the downstream nodes subsidiary to the daughter node, to thereby adjust the number of the downstream nodes subsidiary to the daughter node.

4. The network node in accordance with claim 3, further comprising a storage storing in a form of table the link cost value in connection with information on the daughter node.

5. The network node in accordance with claim 1, wherein, when said network node is connected to a plurality of daughter nodes, said control information producer produces the control information specifically to each of the daughter nodes,
said control information producer adjusting a path cost value, associated with said network node among the path cost information to be respectively inserted into the control information directed to the daughter nodes, according to the number of the downstream nodes subsidiary to the daughter node to thereby adjust the number of the downstream nodes subsidiary to the daughter node.

6. The network node in accordance with claim 5, further comprising a storage storing in a form of table the path cost values correspondingly to information on the respective daughter nodes.

7. A wireless communication network system comprising a network node performing multi-hop wireless communications, said network node comprising:
a control information transmitter/receiver sending or receiving a control packet containing control information to or from a neighboring node in said system, the neighboring node being capable of wirelessly communicating directly with said network node;
a link cost calculator which is operative in response to said control information transmitter/receiver sending or receiving the control information to calculate a link cost value of a link between said network node and the neighboring node;
a path cost calculator calculating, when a packet is sent to a destination node in said system, a path cost value incurred until the packet arrives at the destination node;
a downstream node manager managing a number of downstream nodes subsidiary to a daughter node of said network node on a path over which the packet sent arrives at the destination node; and
a control information producer producing the control information to be sent by said control information transmitter/receiver,
said control information producer inserting, into the information to be produced, link cost information based on the link cost value calculated by said link cost calculator and/or path cost information based on the path cost value calculated by said path cost calculator,
said control information producer being operable in response to the number of the downstream nodes subsidiary to the daughter node to adjust a content of the link cost information or the path cost information, to be inserted into the control information to be produced, to thereby adjust the number of the downstream nodes subsidiary to the daughter node.
